(19) United States
(12) Patent Application Publication
(10) Pub. No.: US 2004/0256911 A1
(43) Pub. Date: Dec. 23, 2004

(54) Braking device for four-wheel vehicle

(75) Inventors: Kunimichi Hatano, Wako-shi (JP); Takehiro Horiuchi, Wako-shi (JP); Kiyotaka Minoura, Wako-shi (JP); Osamu Yamamoto, Wako-shi (JP)

Correspondence Address: Carrier Blackman & Associates, P.C., 24101 Novi Road #100, Novi, MI, 48375, US

(73) Assignee: Honda Motor Co., Ltd., Tokyo (JP)

(21) Appl. No.: 10/838,177

(22) Filed: May 3, 2004

(30) Foreign Application Priority Data
May 27, 2003 (JP) 2003-149014

(51) Int. Cl. B60T 13/74

(52) U.S. Cl. 303/3

(57) ABSTRACT

A braking device for a four-wheel vehicle includes a first front wheel brake pair including a hydraulic brake and an electric brake, to brake one front wheel; a second front wheel brake pair including a hydraulic brake and an electric brake, to brake the other front wheel; a first rear wheel electric brake to brake one rear wheel; and a second rear wheel electric brake to brake the other rear wheel. Thus, the braking device can use the hydraulic brakes and the electric brakes by rationally combining them, while eliminating need for a booster and avoiding increase in the size of a hydraulic pressure source and in the voltage of a power source.

### BACKGROUND OF THE INVENTION

1. Field of the Invention

The present invention relates to a braking device for a four-wheel vehicle including a pair of left and right front wheels and a pair of left and right rear wheels.

2. Description of the Related Art

An EHB (electric hydraulic brake) and an EMB (electric mechanical brake) are conventionally known as braking devices for a four-wheel vehicle from Japanese Patent Application Laid-Open Nos. 9-188242 and 2000-74106 and the like.

In the conventional EHB and EMB, mechanical connection between a brake pedal and a wheel brake is cut off, a braking target value is set in accordance with operation input by an operator to a brake pedal, the operation input being electrically detected, and the hydraulic or electric wheel brake is operated based on the braking target value.

Also, there is a known art in which a braking target value for a predetermined wheel is set not only in accordance with the operation input of the operator to the brake pedal but also in accordance with a traveling condition of the vehicle, thereby meticulously performing brake control.

In a four-wheel vehicle, whether it is an FF type vehicle or an FR type vehicle, the vehicle weight moves forward at the time of braking, so that ground contact pressure of the rear wheels decreases while ground contact pressure of the front wheels increases. Therefore, it is required to apply larger braking force to the front wheels than to the rear wheels, and thus it is necessary to correspondingly increase the maximum braking force (braking force capacity) of the front wheel brake. For example, in an FF type vehicle with large front axle weight, it is effective to distribute the braking force to the front wheels and the rear wheels in a ratio of approximately 2 to 1 in order to enhance the braking efficiency. When the EHB is adopted for that effect, high hydraulic pressure is required, inevitably leading to increase in the size of a hydraulic pressure source for generating such a pressure, namely, a hydraulic pump, or to use of a booster. When the EMB is adopted, it requires a high voltage, and therefore a power source of, for example, 42V system, which is higher than normal voltage of 12V, has to be prepared.

### SUMMARY OF THE INVENTION

The present invention has been achieved in view of the above-mentioned circumstances, and has an object to provide a braking device for a four-wheel vehicle which can be constructed to be comparatively small by rationally combining a hydraulic brake and an electric brake, thereby eliminating conventional need for a booster and avoiding increase in the size of a hydraulic pressure source and in the voltage of a power source.

In order to achieve the object, according to a first feature of the present invention, there is provided a braking device for a four-wheel vehicle including a pair of left and right front wheels and a pair of left and right rear wheels, comprising a first front wheel brake pair comprising a hydraulic brake operated by hydraulic pressure generated by a hydraulic pressure generator operated by operation input of an operator, and an electric brake operated by a driving force of an electric motor, to brake one front wheel, a second front wheel brake pair comprising a hydraulic brake operated by the hydraulic pressure generated by the hydraulic pressure generator, and an electric brake operated by a driving force of an electric motor, to brake the other front wheel, a first rear wheel electric brake operated by a driving force of an electric motor, to brake one rear wheel, and a second rear wheel electric brake operated by a driving force of an electric motor, to brake the other rear wheel.

With the first feature, the braking force is substantially equally shared by the hydraulic brakes and the electric brakes in the first and second front wheel brake pairs suffering particularly large braking load, thereby greatly reducing the maximum braking force required of each brake.

The thus-reduced maximum braking force of the hydraulic brake dispenses with a need for a booster which is generally required in the hydraulic brake, so that the hydraulic brake can be sufficiently operated by depending on only the muscle force of the operator.

Also, the reduced maximum braking force of the electric brake reduces the power consumption of the electric brakes, and enables use of a power source of a low voltage system, which further contributes to reduction in the size of an electric motor and a speed reducer.

Since the hydraulic brake is operated by the hydraulic pressure generated by the hydraulic pressure generator which is operated by the operation input of the operator, the operator can receive reaction force from the hydraulic pressure generator at the time of braking operation, thereby obtaining favorable braking operation feeling without using a stroke simulator which has been needed in the conventional EMB and EHB.

At the time of failure of the electric system, the function of the hydraulic brake is kept to be normal, and therefore the degree of safety design provided for the power source shutdown can be lowered, thus minimizing increase in the size of the braking device to reduce the cost.

In addition to the first feature, according to a second feature of the present invention, the hydraulic generator is constructed of a master cylinder having a first hydraulic pressure chamber and a second hydraulic pressure chamber for generating hydraulic pressure by operation input, the first hydraulic pressure chamber is connected to the hydraulic brake of the first front wheel brake pair, and the second hydraulic pressure chamber is connected to the hydraulic brake of the second front wheel brake pair; a first hydraulic pressure sensor for detecting hydraulic pressure of the first hydraulic pressure chamber, and a second hydraulic pressure sensor for detecting hydraulic pressure of the second hydraulic pressure chamber are provided; target braking forces of the electric brake of the second front wheel brake pair and the second rear wheel electric brake are set based on a hydraulic pressure detection value of the first hydraulic pressure sensor; and target braking forces of the electric brake of the first front wheel brake pair and the first rear wheel electric brake are set based on a hydraulic pressure detection value of the second hydraulic pressure sensor.

With the second feature, the electric brake of the second front wheel brake pair and the second rear wheel electric brake can be operated based on the hydraulic pressure detection value of the first hydraulic pressure sensor so as to obtain the respective target braking forces, and the electric brake of the first front wheel brake pair and the first rear wheel electric brake can be operated based on the hydraulic pressure detection value of the second hydraulic pressure sensor so as to obtain the respective target braking forces.

Even when any one of the hydraulic pressure sensors fails as a result of using the first and second hydraulic pressure sensors, only two electric brakes become inoperable among the total of six brakes including the two hydraulic brakes and four electric brakes, and therefore reduction in the total braking force can be suppressed by half or less. In addition, reduction in the braking efficiency can be minimized by securing the functions of the hydraulic brakes of both the front wheel brake pairs.

In the case where one of the hydraulic systems of the master cylinder fails, e.g., if the hydraulic system of either one of the first and second hydraulic pressure chambers of the master cylinder M fails, the hydraulic brake of one of the first and second front wheel brake pairs, the electric brake of the other of the first and second front brake pairs, and the electric brake of the other of the first and second rear wheel electric brakes become inoperable, but the remaining operable three brakes are assigned one by one to the left and right front wheels, as well as the left or right rear wheel. Accordingly, concentration of the braking force to a particular wheel can be avoided while the left and right front wheels are braked.

The above-mentioned object, other objects, characteristics, and advantages of the present invention will become apparent from an explanation of a present embodiment, which will be described in detail below by reference to the attached drawings.

### BRIEF DESCRIPTION OF THE DRAWINGS

FIG. 1 is a system diagram of a braking device for a four-wheel vehicle according to an embodiment of the present invention.

FIGS. 2A, 2B, 2C and 2D are explanatory diagrams of an operation of the embodiment.

### DESCRIPTION OF THE PRESENT EMBODIMENT

The present invention will be hereinafter described based on a present embodiment of the present invention shown in the attached drawings.

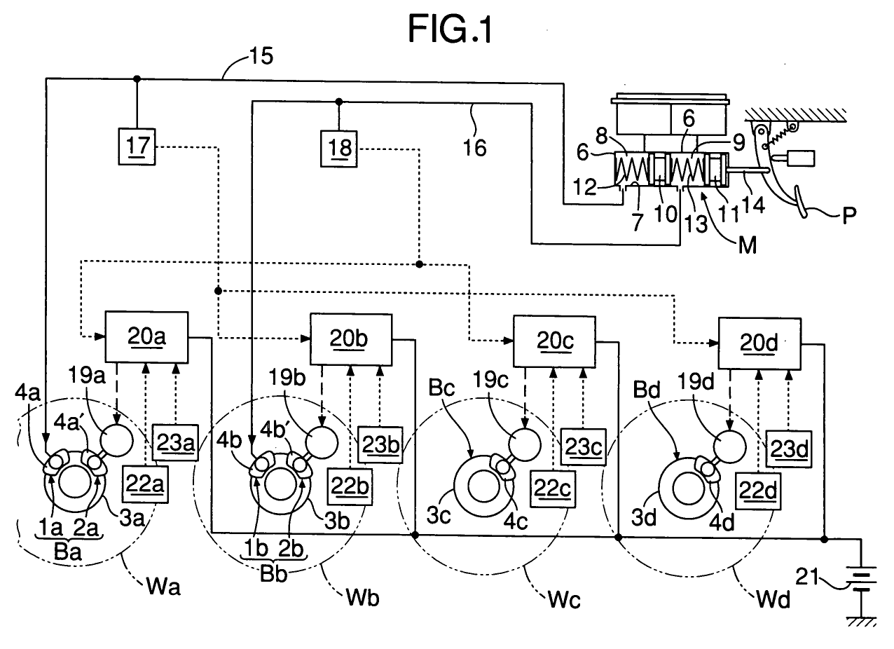

First, in FIG. 1, a four-wheel vehicle includes a pair of left and right front wheels Wa and Wb and a pair of left and right rear wheels Wc and Wd. The left front wheel Wa is provided with a first front wheel brake pair Ba for braking the left front wheel Wa, and the right front wheel Wb is provided with a second front wheel brake pair Bb for braking the right front wheel Wb. The left rear wheel Wc is provided with a first rear wheel brake Bc for braking the left rear wheel Wc, and the right rear wheel Wd is provided with a second rear wheel brake Bd for braking the right rear wheel Wd.

The first front wheel brake pair Ba is constituted of a hydraulic brake 1a and an electric brake 2a, which shares a brake disk 3a rotating integrally with the left front wheel Wa.

The hydraulic brake 1a includes a pair of friction pads (not shown) disposed on opposite side surfaces of the brake disk 3a, and a brake caliper 4a having a hydraulic piston capable of pressing these friction pads against the opposite side surfaces of the brake disk 3a. The brake caliper 4a is mounted to a knuckle for supporting the left front wheel Wa.

The electric brake 2a includes a pair of friction pads (not shown) disposed on opposite side surfaces of the brake disk 3a, a brake caliper 4a′ having a piston capable of pressing these friction pads against the opposite side surfaces of the brake disk 3a, and an electric motor 19a operated to press the piston of the brake caliper 4a′. The brake caliper 4a′ is also mounted to a knuckle for supporting the left front wheel Wa.

The second front wheel brake pair Bb is constituted of a hydraulic brake 1b and an electric brake 2b, which shares a brake disk 3b rotating integrally with the right front wheel Wb.

The hydraulic brake 1b includes a pair of friction pads (not shown) disposed on opposite side surfaces of the brake disk 3b, and a brake caliper 4b having a hydraulic piston capable of pressing these friction pads against the opposite side surfaces of the brake disk 3b. The brake caliper 4b is mounted to a knuckle for supporting the right front wheel Wb.

The electric brake 2b includes a pair of friction pads (not shown) disposed on opposite side surfaces of the brake disk 3b, a brake caliper 4b′ having a piston capable of pressing these friction pads against the opposite side surfaces of the brake disk 3b, and an electric motor 19b operated to press the piston of the brake caliper 4b′. The brake caliper 4b′ is also mounted to a knuckle for supporting the right front wheel Wb.

In order to operate the hydraulic brakes 1a and 1b of the first and second front wheel brake pairs Ba and Bb, a master cylinder M is provided as a hydraulic pressure generating device for supplying hydraulic pressure to the hydraulic brakes 1a and 1b. The master cylinder M is constructed to be a tandem-type including: a cylinder body 6; first and second pistons 10 and 11 fitted into a cylinder hole 7 of the cylinder body 6 to define a first hydraulic pressure chamber 8 at a front side and a second hydraulic pressure chamber 9 at a rear side in the cylinder hole 7; and first and second return springs 12 and 13 housed in the first and second hydraulic pressure chambers 8 and 9 to bias respectively the first and second pistons 10 and 111 to a retreating direction. A brake pedal P is connected to the second piston 11 via an input rod 14.

The first hydraulic pressure chamber 8 is connected via a first oil passage 15 to an output hydraulic pressure chamber of the brake caliper 4a of the hydraulic brake 1a of the first front wheel brake pair Ba. The second hydraulic pressure chamber 9 is connected via a second oil passage 16 to an output hydraulic pressure chamber of the brake caliper 4b of the hydraulic brake 1b of the second front wheel brake pair Bb.

First and second hydraulic pressure sensors 17 and 18 for detecting hydraulic pressures of the first and second hydraulic pressure chambers 8 and 9, are respectively connected to the first and second oil passages 15 and 16.

The first rear wheel brake Bc includes a brake disk 3c rotating integrally with the left rear wheel Wc, a pair of friction pads (not shown) disposed on opposite side surfaces of the brake disk 3c, a brake caliper 4c having a piston capable of pressing these friction pads against the opposite side surfaces of the brake disk 3c, and an electric motor 19c operated to press the piston of the brake caliper 4c.

The second rear wheel brake Bd includes a brake disk 3d rotating integrally with the right rear wheel Wd, a pair of friction pads (not shown) disposed on opposite side surfaces of the brake disk 3d, a brake caliper 4d having a piston capable of pressing these friction pads against the opposite side surfaces of the brake disk 3d, and an electric motor 19d operated to press the piston of the brake caliper 4d.

A first electric motor control unit 20a for controlling the operation of an electric motor 19a of the first front wheel brake pair Ba is connected to the electric motor 19a. A second electric motor control unit 20b for controlling the operation of an electric motor 19b of the second front wheel brake pair Bb is connected to the electric motor 19b. A third electric motor control unit 20c for controlling the operation of an electric motor 19c of the first rear wheel brake Bc is connected to the electric motor 19c. A fourth electric motor control unit 20d for controlling the operation of an electric motor 19d of the second rear wheel brake Bd is connected to the electric motor 19d. These first to fourth electric motor control units 20a to 20d are supplied with electric power from a common power source 21.

A detection signal of the first hydraulic pressure sensor 17 is inputted into the second electric motor control unit 20b and the fourth electric motor control unit 20d, which set target braking force in accordance with the inputted signal and operate the corresponding electric motors 19b and 19d.

A detection signal of the second hydraulic pressure sensor 18 is inputted into the first electric motor control unit 20a and the third electric motor control unit 20c, which set target braking force in accordance with the inputted signal and operate the corresponding electric motors 19a and 19c.

Inputted respectively into the electric motor control units 20a, 20b, 20c and 20d are detection signals from stroke sensors 22a, 22b, 22c and 22d which detect piston strokes in the brake calipers 4a′, 4b′ 4c and 4d of the corresponding electric brakes 2a, 2b, Bc and Bd based on the rotation angles of the electric motors 19a, 19b, 19c and 19d; and detection signals from force sensors 23a, 23b, 23c and 23d which detect pressing forces of the pistons against the friction pads in the brake calipers 4a′, 4b′, 4c and 4d of the corresponding electric brakes 2a, 2b, Bc and Bd.

This embodiment is designed for FF type vehicles, and the hydraulic brakes 1a and 1b of the first and second front wheel brake pairs Ba and Bb are constructed so that the braking force generated by each of the hydraulic brakes 1a and 1b becomes approximately 1/6 of the braking force required by the operator when the operator steps on a brake pedal P. The electric motor control units 20a to 20d are constructed so that, when the electric motor control units 20a to 20d operate the corresponding electric brakes 2a, 2b, Bc and Bd corresponding to detection pressure of the corresponding first or second hydraulic pressure sensor 17 and 18, each braking force becomes approximately 1/6 of the braking force required by the operator.

Next, operations of this embodiment will be explained.

1. At the Time of Normal Braking.

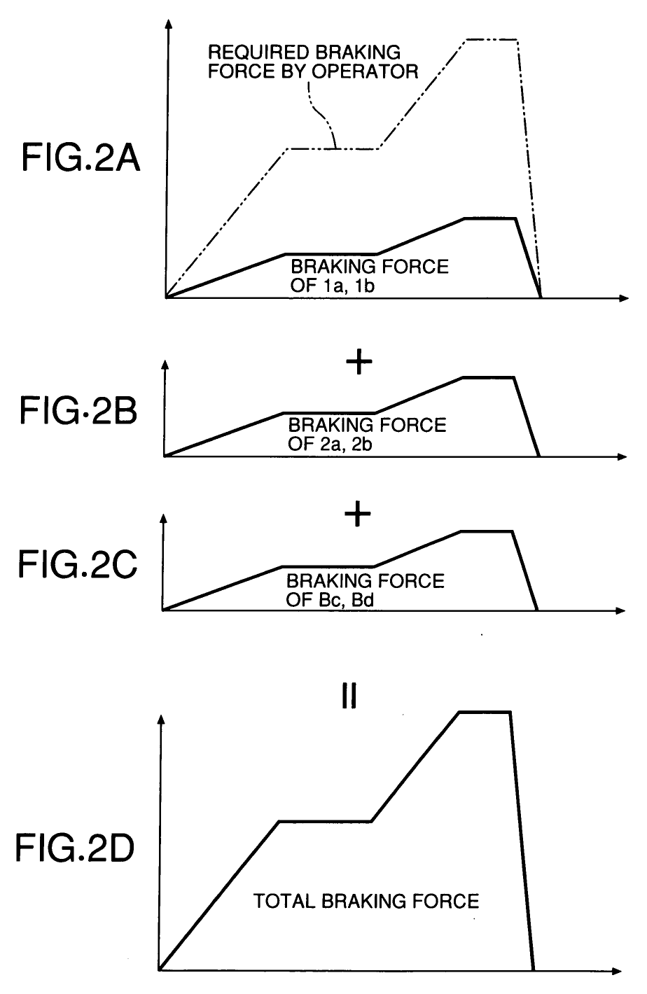

When the operator steps on the brake pedal P during traveling of the four-wheel vehicle, in the master cylinder M, the second piston 11 pressurizes the second hydraulic pressure chamber 9, and the first piston 10 pressurizes the first hydraulic pressure chamber 8, whereby the pressing force to the brake pedal P, namely, hydraulic pressure corresponding to the operation input occurs to both the hydraulic pressure chambers 8 and 9. The hydraulic pressure in the first hydraulic pressure chamber 8 is supplied to the hydraulic brake 1a of the first front wheel brake pair Ba through the first oil passage 15, and the hydraulic pressure in the second hydraulic pressure chamber 9 is supplied to the hydraulic brake 1b of the second front wheel brake pair Bb through the second oil passage 16. The hydraulic pressures operate the hydraulic brakes 1a and 1b to apply the braking forces to the left and right front wheels Wa and Wb. At this time, the braking force from the left and right hydraulic brakes 1a and 1b to the left and right front wheels Wa and Wb respectively are ⅙ of the braking force required by the operator as described above. Therefore, the total braking force of the hydraulic brakes 1a and 1b becomes approximately 1/3 of the braking force required by the operator (see FIG. 2A).

Meanwhile, the first and second hydraulic pressure sensors 17 and 18 detect the braking force required by the operator from the hydraulic pressure of the first and second oil passages 15 and 16, the detection pressure signal of the first hydraulic pressure sensor 17 is inputted into the second and fourth electric motor control units 20b and 20d, and the detection pressure signal of the second hydraulic pressure sensor 18 is inputted into the first and third electric motor control units 20a and 20c.

The first to fourth electric motor control units 20a to 20d operate the electric brakes 2a and 2b of the first and second front wheel brake pairs Ba and Bb, as well as the first and second rear wheel electric brakes Bc and Bd in accordance with the respective input signals, thereby applying the braking force of approximately 1/6 of the braking force required by the operator to each of the corresponding wheels Wa to Wd.

Accordingly, the total braking force of the electric brakes 2a and 2b of the first and second front wheel brake pairs Ba and Bb is ⅓ of the braking force required by the operator (see FIG. 2B), and therefore the total braking force of the first and second brake pairs Ba and Bb becomes approximately 2/3 of the braking force required by the operator.

In contrast, the total braking force of the first and second rear wheel electric brakes Bc and Bd is ⅓ of the braking force required by the operator (see FIG. 2C).

Thus, in the FF type vehicle with large front axle weight, the front wheels Wa and Wb and the rear wheels Wc and Wd can be braked with an ideal braking force distribution ratio of approximately 2 to 1, thereby contributing to enhancement of braking efficiency.

Also, since the left and right front wheel brakes suffering particularly large braking load are constituted respectively of the first and second front wheel brake pairs Ba and Bb respectively comprising the hydraulic brakes 1a and 1b and the electric brakes 2a and 2b, the braking force can be substantially equally shared by the hydraulic brakes 1a and 1b and the electric brakes 2a and 2b, whereby the maximum braking force required of each of the brakes 1a and 1b; and 2a and 2b can be reduced to approximately half values, respectively.

Thus, the reduction by half of the maximum braking force of the hydraulic brakes 1a and 1b eliminates need for a booster which is generally required in a hydraulic brake, and enables the operation of the hydraulic brake by depending on only a muscle force of the operator.

The reduction by half of the maximum braking force of the electric brakes 2a and 2b reduces power consumption of the electric brakes 2a and 2b, and enables use of a power source of a lower voltage system, which further contributes to reduction in size of the electric motors 19a and 19b, a speed reducer and the like.

Since the hydraulic brakes 1a and 1b are operated by the hydraulic pressure generated by the master cylinder M operated by the operation input of the operator, the operator can receive the reaction force from the master cylinder M during braking operation, and therefore the operator can obtain favorable braking operation feeling without using a stroke simulator which has been required in the conventional EMB and EHB.

Further, at the time of failure of the electric system, the function of the hydraulic brake is kept to be normal, and therefore the degree of safety design provided for the power source shutdown can be lowered, thus minimizing increase in the size of the braking device to reduce the cost.

2. At the Time of Failure of One of the Hydraulic Pressure Sensors

If either one of the first sensor 17 or the second sensor 18, for example, the first sensor 17 fails during braking, two brakes that are the electric brake 2b of the second front wheel brake pair Bb and the second rear wheel electric brake Bd, which are controlled by the second and fourth electric control units 20b and 20d based on the detected hydraulic pressure of the first hydraulic pressure sensor 17, become inoperable, while the other four brakes operate normally. Therefore, braking force loss is 2/6=⅓ of the braking force required by the operator, in other words, 4/6=⅔ of the braking force required by the operator can be secured, that is, reduction in the total braking force can be reduced by half or less. In addition, reduction in the braking efficiency can be minimized by securing the functions of the hydraulic brakes 1a and 1b of both the front wheel brake pairs Ba and Bb.

3. At the Time of Failure of One of the Hydraulic Systems of the Master Cylinder M

If the hydraulic system of either one of the first hydraulic pressure chamber 8 or the second hydraulic pressure chamber 9 of the master cylinder M, for example, the first hydraulic pressure chamber 8 fails, the brakes which become inoperable are the hydraulic brake 1a of the first front wheel brake pair Ba, the electric brake 2b of the second front wheel brake pair Bb, and the second rear wheel electric brake Bd, and the remaining operable three brakes 2a, 1b and Bc are assigned one by one to the left and right front wheels Wa and Wb as well as the left or right rear wheel W. Accordingly, concentration of the braking force to a particular wheel can be avoided while the front wheels Wa and Wb are braked.

4. At the Time of Failure of the Electric System

In the worst case, at the time of failure of the electric system including the power source 21 and the electric circuit connected thereto, all the four electric brakes 2a, 2b, Bc and Bd become inoperable, but even in this case, the hydraulic brakes 1a and 1b of the first and second front wheel brake pairs Ba and Bb function normally, and therefore minimum required braking force (braking force of 2/6=⅓ of the braking force required by the operator) can be given to the left and right front wheels Wa and Wb suffering large braking load.

The present invention is not limited to the described embodiment, and various changes in the design can be made therein without departing from the subject matter of the present invention. For example, the brake pair Bb for the right front wheel may be used as the first front wheel brake pair, the brake pair Ba for the left front wheel may be used as the second front wheel brake pair, the electric brake Bd for the right rear wheel may be used as the first rear wheel electric brake, and the electric brake Bc for the left rear wheel may be used as the second rear wheel electric brake. It goes without saying that, when the present invention is applied to an FR type vehicle, the target braking force of each brake is set in accordance with an appropriate braking force distribution ratio to the front wheels and the rear wheels of the FR type vehicle.

What is claimed is:

1. A braking device for a four-wheel vehicle including a pair of left and right front wheels and a pair of left and right rear wheels, comprising:
a first front wheel brake pair comprising a hydraulic brake operated by hydraulic pressure generated by a hydraulic pressure generator operated by operation input of an operator, and an electric brake operated by a driving force of an electric motor, to brake one front wheel;
a second front wheel brake pair comprising a hydraulic brake operated by the hydraulic pressure generated by the hydraulic pressure generator, and an electric brake operated by a driving force of an electric motor, to brake the other front wheel;
a first rear wheel electric brake operated by a driving force of an electric motor, to brake one rear wheel; and
a second rear wheel electric brake operated by a driving force of an electric motor, to brake the other rear wheel.

2. The braking device for the four-wheel vehicle according to claim 1,
wherein the hydraulic generator includes a master cylinder having a first hydraulic pressure chamber and a second hydraulic pressure chamber for generating hydraulic pressure by operation input, the first hydraulic pressure chamber is connected to the hydraulic brake of the first front wheel brake pair, and the second hydraulic pressure chamber is connected to the hydraulic brake of the second front wheel brake pair;
the braking device further comprises a first hydraulic pressure sensor for detecting hydraulic pressure of the first hydraulic pressure chamber, and a second hydraulic pressure sensor for detecting hydraulic pressure of the second hydraulic pressure chamber;
wherein target braking forces of the electric brake of the second front wheel brake pair and the second rear wheel electric brake are set based on a hydraulic pressure detection value of the first hydraulic pressure sensor; and
wherein target braking forces of the electric brake of the first front wheel brake pair and the first rear wheel electric brake are set based on a hydraulic pressure detection value of the second hydraulic pressure sensor.

3. The braking device for the four-wheel vehicle according to claim 1,
wherein a braking force generated by each of said hydraulic and electric brakes is approximately equal.

4. The braking device for the four-wheel vehicle according to claim 1,
wherein each of said hydraulic brakes is operated by only the hydraulic pressure generated by the hydraulic pressure generator operated by the operation input of the operator.

5. The braking device for the four-wheel vehicle according to claim 1,
wherein a braking force applied to either of the front wheels is substantially equally shared by the hydraulic brake and the electric brake in the corresponding first or second front wheel brake pair.

6. The braking device for the four-wheel vehicle according to claim 1,
wherein said electric brakes are operated by a low voltage power source.

7. The braking device for the four-wheel vehicle according to claim 1,
wherein target braking forces of the electric brake of the second front wheel brake pair and the second rear wheel electric brake are controlled based on a hydraulic pressure of the hydraulic brake of the first front wheel brake pair; and
target braking forces of the electric brake of the first front wheel brake pair and the first rear wheel electric brake are controlled based on a hydraulic pressure of the hydraulic brake of the second front wheel brake pair.
